(19) United States
(12) Patent Application Publication
(10) Pub. No.: US 2018/0277004 A1
(43) Pub. Date: Sep. 27, 2018

(54) QUESTION ASSESSMENT

(71) Applicant: Hewlett-Packard Development Company, L.P., Houston, TX (US)

(72) Inventors: Robert B Taylor, Vancouver, WA (US); Udi Chatow, Palo Alto, CA (US); Bruce Williams, San Diego, CA (US)

(21) Appl. No.: 15/761,482

(22) PCT Filed: Dec. 18, 2015
(86) PCT No.: PCT/US2015/066904

§ 371 Date: Mar. 20, 2018

(51) Int. Cl. G09B 7/02; G09B 7/06; G06K 9/00

(52) U.S. Cl. CPC G09B 7/02; G06K 2209/01; G06K 9/00442; G09B 7/06

(57) ABSTRACT

Examples disclosed herein relate to capturing a set of responses to a plurality of questions, scanning a machine-readable link comprising a unique identifier associated with the plurality of questions, and associating the set of responses with the unique identifier.

### BACKGROUND

In some situations, a set of questions may be created, such as for a test or survey. The questions may also be paired with an answer key and/or may be associated with free-form answer areas. For example, some questions may be multiple choice while others may be fill-in-the-blank and/or essay type questions. The questions may then be submitted for evaluation and/or assessment.

### BRIEF DESCRIPTION OF THE DRAWINGS

In the accompanying drawings, like numerals refer to like components or blocks. The following detailed description references the drawings, wherein:

FIG. 1 is a block diagram of an example question assessment device;

FIGS. 2A-2C are illustrations of example machine-readable codes;

FIGS. 3A-3B are illustrations of example generated tests;

FIG. 4 is a flowchart of an example of a method for providing question assessment; and

FIG. 5 is a block diagram of an example system for providing question assessments.

### DETAILED DESCRIPTION

In some situations, a set of questions may be prepared to be presented and answered by one and/or more recipients. The questions may comprise multiple choice, fill-in-the-blank, essay, short answer, survey, rating, math problems, and/or other types of questions. For example, a teacher may prepare a set of 25 questions of various types for a quiz.

Conventional automated scoring systems, such as Scantron® testing systems, may compare answers on a carefully formatted answer sheet to an existing answer key, but such sheets must be precisely filled in with the correct type of pencil. Further, such sheets rely on a known order of the questions. This allows for easy copying of answers from one student to another and also introduces errors when a student fails to completely fill out the bubbles to mark their answers.

Randomizing the question order will greatly reduce the incidence of cheating and copying among students. Further, the ability to recognize which questions appear in any order allows for automated collection of answers to each question. In some implementations, not only multiple choice answers may be graded, but textual answers, such as fill in the blank responses, may be recognized using optical character recognition (OCR) and compared to stored answers.

Each student may be associated with a unique identifier that may be embedded in the test paper. Such embedding may comprise an overt (plain-text) and/or covert signal such as a watermark or matrix code. Since every paper may comprise a unique code with a student identifier and/or a test version #, a different test sequence may be created per student, making it hard or impossible to copy from student neighbors while still enabling an automated scan and assessment solution. The automated assessment may give immediate feedback some and/or all of the questions, such as by comparing a multiple choice or OCR'd short text answer to a correct answer key. These results may, for example, be sent by email and/or to a application.

In some implementations, the test will have a combination of choosing the correct or best answer and also requesting to show and include the process of getting to the answer chosen. In other words, in some cases the form will have a question, with a set of multiple choice answers for the student to choose from and also a box to elaborate on how the student arrived at the answer. In this way, there may be an immediate response and assessment/evaluation for the student based on the multiple choice answers and a deeper feedback from the teacher that can request to evaluate all the students who had a mistake in answer #4 to see what the common mistakes were.

The paper test form may be captured in a way that each answer can be individually sent for analysis directly to the instructor/teacher or to a student's file. This may include multiple choice answers as well as the text box with the free-response text answer and/or sketch which is positioned in a predefined area and positioning on the paper test form. A scanning device may be used to capture the paper test form, such as a smartphone, tablet or similar device with a camera that can scan and capture an image of the test form and/or a standalone scanner. Upon scanning, the paper's unique machine-readable code (e.g., watermark) may be identified and associates the answers with the student ID and the specific test sequence expected. The answers and the immediate results of the multiple choice answers may be presented and/or delivered to the student. In cases where mistakes were made, the student may receive a recommendation of content to close the knowledge gap. A teacher/instructor, in class or remotely, may review the answers and give the student additional personal feedback. In some cases, teachers would like to understand class trends and gaps by analyzing all answers to a particular question to see what common mistakes were made to help the teacher focus on the areas of weakness. The association of assessment scores to a particular student may be made via a unique and anonymized identifier associated with the test paper, which can tell which student completed an assessment via the unique identifier embedded in the assessment's machine-readable code. Since the teacher/instructor no longer has to associate an assessment with a particular student, the identity of the student who completed the assessment can be kept hidden, greatly minimizing the chance of the teacher applying personal bias while grading. Further, the teacher may choose to review all students' responses to a particular question, such as question 4, in order to focus on that answer. The teacher may then move on to reviewing all students' responses to the next question, rather than grading all of the questions on the assessment/test for each student in turn.

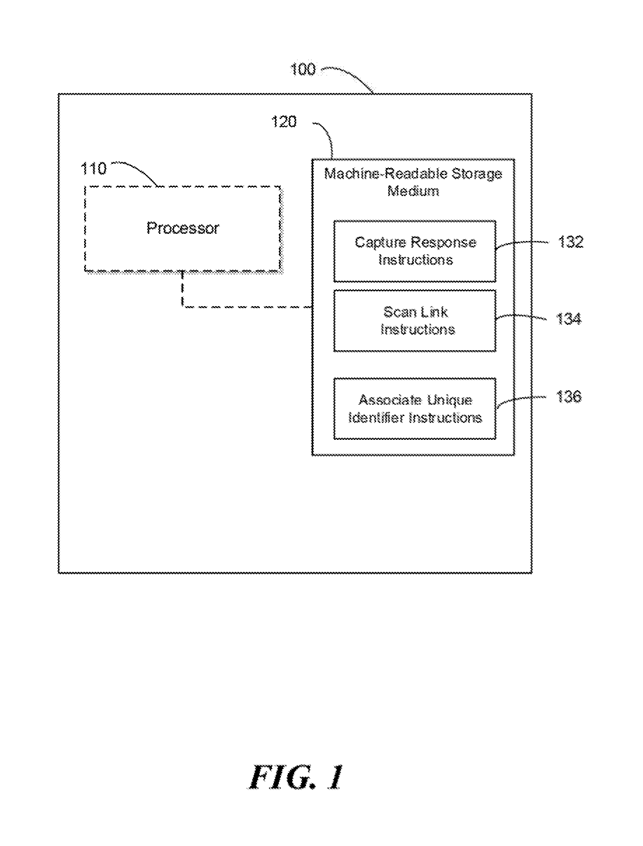

Referring now to the drawings, FIG. 1 is a block diagram of an example question assessment device 100 consistent with disclosed implementations. Question assessment device 100 may comprise a processor 110 and a non-transitory machine-readable storage medium 120. Question assessment device 100 may comprise a computing device such as a server computer, a desktop computer, a laptop computer, a handheld computing device, a smart phone, a tablet computing device, a mobile phone, a network device (e.g., a switch and/or router), or the like.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 120. In particular, processor 110 may fetch, decode, and execute a plurality of capture response instructions 132, generate scan link instructions 134, and associate unique identifier instructions 136 to implement the functionality described in detail below.

Executable instructions may comprise logic stored in any portion and/or component of machine-readable storage medium 120 and executable by processor 110. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Capture response instructions 132 may capture a set of responses to a plurality of questions, wherein the set of responses comprises at least one free-form response. Capture response instructions 132 may, in some implementations, recognize a plurality of markup styles associated with a multiple choice type question. For example, a multiple choice response style may comprise a whole and/or partially filled-in circle, an X and/or other marking on the answer and/or the circle associated with the answer, and/or circling the answer.

Capture response instructions 132 may, for example, detect the pen/pencil marks that have been added to the responses by differentiating between the layout of the question before and after the responses have been written in. A pixel-by-pixel comparison, for example, may compare a color value for each relative pixel to determine if new writing has been added. A white pixel may read as a hex value of #FFFFFF, while a grey pixel (representing a pencil mark in this example) may read as a hex value of #474747. These values are only examples, as numerous other values may be represented, as the detection may rely on a threshold difference in the values to determine that a mark has been made. In some implementations, larger sample areas than a single pixel may be compared, such as by averaging the color values of the area and comparing between the before and after layouts. Once areas of writing have been detected, they may be assembled into shapes, such as by connecting marked pixels into an “X” or circle shape and then identifying the relative location of the shape to associate that shape with a particular answer. Comparison of pixel value differences is offered as an example only, and other methods of scanning and detection of markings on the responses are contemplated.

The questions may be stored in a question database associated with a teaching/instructional application. Such questions and their layout may be retrieved to compare to the marked up version to aid in capturing the responses. For example, an instructor may enter the questions in an app on their tablet and/or smart device, through a web-based user interface, through an application on a desktop or laptop, etc. Each question may comprise the actual display information of the question (text, figures, drawings, references, tables, etc.), a question type (e.g., short answer, multiple choice, sketch, essay, etc.), and/or any constraint rules, as described above. For multiple-choice type questions, the answer choices may also be entered. The question type may be then be used to define an amount of space needed on a page. For example, a multiple choice question may require two lines for the question, an empty space line, and a line for the list of possible answers. For free-form and/or essay type questions, the instructor may enter a recommended amount of answer space (e.g., three lines, half a page, a full page, etc.). The instructor/teacher may also enter the correct answers and/or keywords into the application for later grading.

In some implementations, capture response instructions 132 may further compare at least one response of the set of responses to an answer key of correct responses. For example, once a filled-in circle has been identified and located next to answer choice B, the correct answer for the question may be retrieved and compared. If the correct answer is B, then the question may be scored as correct; otherwise the question may be scored as incorrect. In some implementations, the correct answer may be displayed next to the captured answer for verification by an instructor. For example, for a short answer response, the text of the response may be displayed next to an expected answer. In other examples, stored answer keywords may be compared to the captured response, such as via optical character recognition (OCR). The keywords may be used to mark the response as correct or incorrect, and/or may be used to highlight appropriate words in the response to aid an instructor when reviewing the responses. For example, certain names may be highlighted in a history essay response.

Upon detection of a correct and/or incorrect response, an indication of the correctness may be provided. For example, capture response instructions 132 may provide a printout and/or display of all scored responses and/or an indication of which response should have been entered. For another example, capture response instructions 132 may provide a count of correct and/or incorrect responses.

Scan link instructions 134 may scan a machine-readable link comprising a unique identifier associated with the plurality of questions. The unique identifier may identify a student associated with the responses and/or may provide layout information for the test. For example, the unique identifier may specify that of 10 possible questions, the associated test presented the questions in the order 3, 7, 1, 2, 9, 10, 8, 4, 6, 5. This may be used to retrieve and/or recreate the layout of the unmarked questions to aid in comparison and detection of the response markings. The captured questions may be associated with a machine-readable code of the unique identifier. The machine-readable code may comprise, for example, a bar code, a matrix code, a text string, and a watermark. The machine-readable code may be visible to a person, such as a large bar code, and/or may not be readily visible, such as a translucent watermark and/or a set of steganography dots. The code may be used to identify the selected questions, a class period, a student, and/or additional information. In some implementations, the code may be added in multiple sections, such as a small matrix code at one and/or more of the corners of the page.

Associate unique identifier instructions 136 may associate the set of responses with the unique identifier. The unique identifier may be used to associate the responses with a particular student. For example, each test paper may have a different identifier even when the questions appear in the same order. This identifier may be associated with a particular student's name and/or student identifier. For example, OCR may be used to recognize the student's written name on the paper. In some implementations, only the unique identifier may be used during assessment and scoring by the instructor in order to anonymize the responses and prevent grading bias. The unique identifier and student name may be associated without being visible, such as by storing the relationship in a database, such that the grades, comments, and any other assessments may be provided to the student.

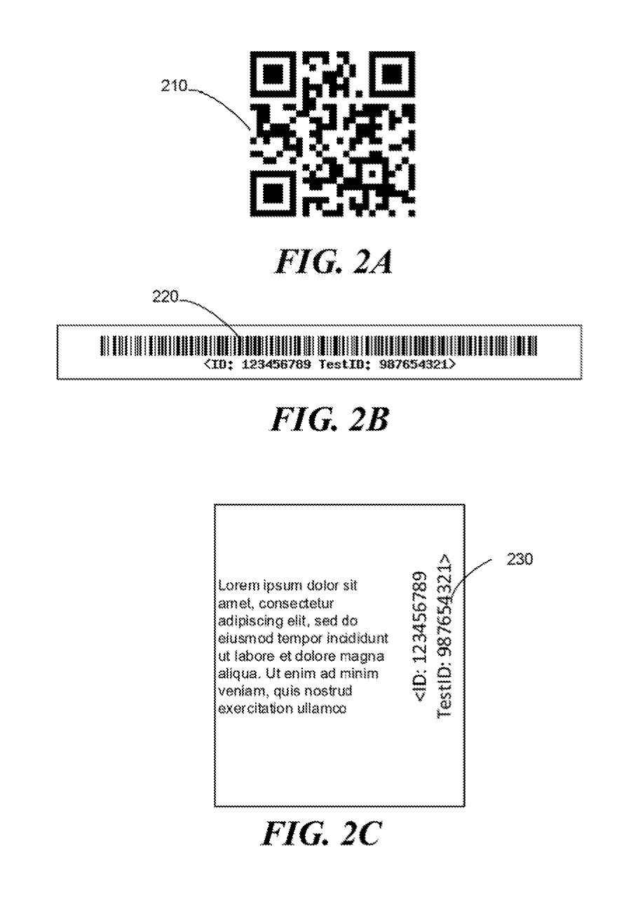

FIG. 2A is an illustration of an example machine-readable code comprising a matrix code 210.

FIG. 2B is an illustration an example machine-readable code comprising a bar code 220.

FIG. 2C is an illustration of an example machine-readable code comprising a watermark 230.

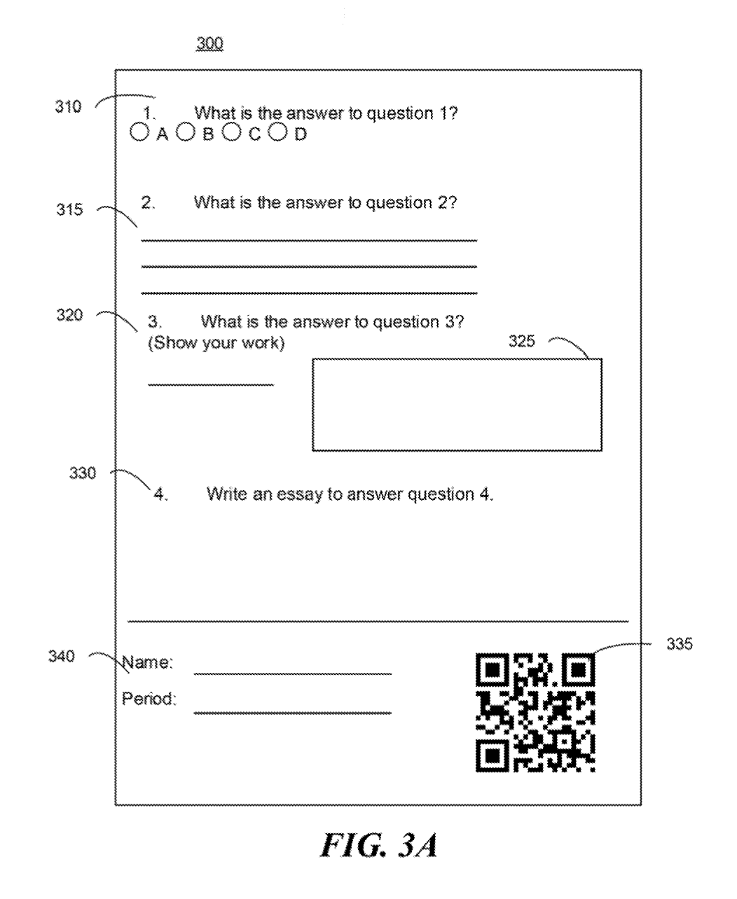

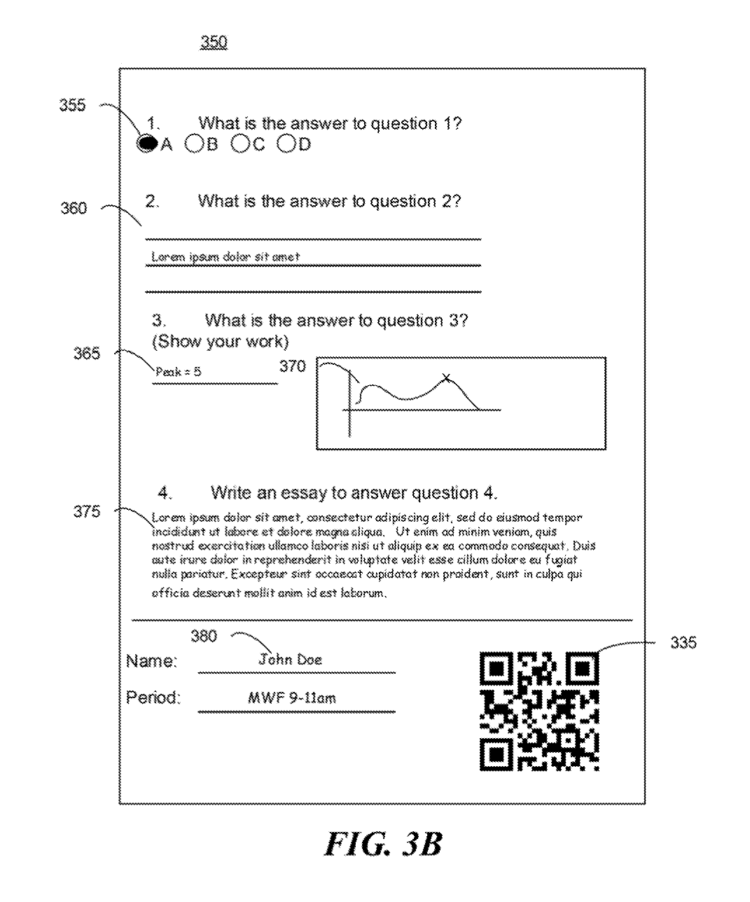

FIG. 3A is an illustration of an example generated test 300. Generated test 300 may comprise a plurality of different question types, such as a multiple choice question 310, a free-form answer question 315, a short answer question 320 with a pre-defined answer area 325, such as may be used for a sketch or to show work, and an essay question 330. Generated test 300 may further comprise a machine-readable code 335 comprising a unique identifier. Machine-readable code 335 may be displayed anywhere on the page and may comprise multiple machine-readable codes, such as a small bar or matrix code at each corner and/or a watermark associated with one, some, and/or all of the questions. Generated test 300 may further comprise a name block 350.

In some implementations, name block 340 may be omitted when a student identifier is already assigned to the generated test 300. The student identifier may, for example, be encoded into machine-readable code 335. In some implementations, name block 340 may be scanned along with the answered questions and the student's name and/or other information may be extracted and associated with the answers.

FIG. 3B is an illustration of an example completed test 350. Completed test 350 may comprise a marked multiple choice answer bubble 355, a free-form answer 360, a short answer 365, a sketch/work response 370, an essay answer 375, and a completed name block 380. Completed test 350 may also comprise the machine-readable link 335 comprising the test's unique identifier.

Capture response instructions 132 may, for example, recognize the bubbles for multiple choice responses by retrieving a stored position on the page layout. For example, a stored question may have a known number of possible multiple chance answers (e.g., four—A, B, C, and D). The position for a bubble associated with each possible answer may be stored in an absolute location (e.g., relative to a corner and/or other fixed position on the page) and/or a relative location (e.g., relative to the associated question text and/or question number). For example, the position for the bubble for choice A may be defined as 100 pixels over from the side of the page and 300 pixels down from the top of the page. The position for the bubble for choice B may be defined as 200 pixels over from the side of the page and 300 pixels down from the top. In some implementations, B's bubble may be defined relative to A's bubble, such as 100 pixels right of the bubble for choice A. Such positions may be stored when the page layout for the test is generated and/or the page may be scanned when the answers are submitted and the positions of the bubbles stored as they are recognized (such as by an OCR process).

The recognition process may use multiple passes to identify marked and/or unmarked multiple choice answer bubbles. For example, a scanner may detect any markings of an expected bubble size (e.g., 80-160% of a known bubble size based on pixel width). The scanner may then perform an analysis of each detected potential bubble to detect whether the bubble has been filled in by comparing the colors and isolating filled circles (or other regular and/or irregular) shapes and/or markings (e.g., crosses). In some implementations, a marked bubble may be detected when a threshold number of pixels of the total number of pixels in the answer bubble have been marked. For example, marked multiple choice answer 355 has a bubble that has been approximately 90% filled in, which may be determined to be a selection of that response.

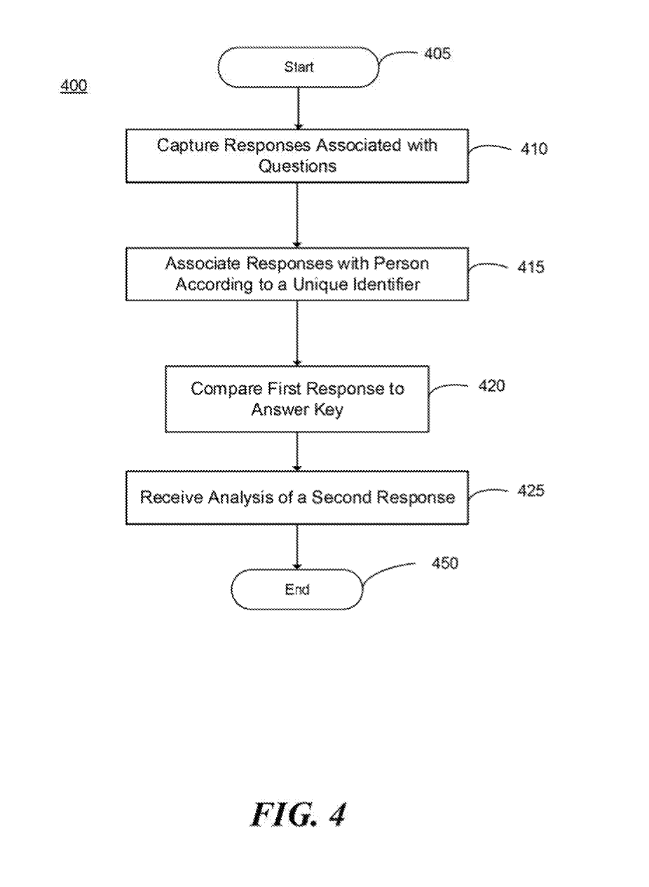

FIG. 4 is a flowchart of an example method 400 for providing question assessment consistent with disclosed implementations. Although execution of method 400 is described below with reference to device 100, other suitable components for execution of method 400 may be used.

Method 400 may begin in stage 405 and proceed to stage 410 where device 100 may capture a set of responses associated with a printed plurality of questions, wherein the plurality of questions comprise a plurality of question types. Question types may comprise, for example, multiple choice, essay, short answer, free-form, mathematical, sketch, etc. For example, capture response instructions 132 may capture a set of responses to a plurality of questions, wherein the set of responses comprises at least one free-form response. Capture response instructions 132 may, in some implementations, recognize a plurality of markup styles associated with a multiple choice type question. For example, a multiple choice response style may comprise a whole and/or partially filled-in circle, an X and/or other marking on the answer and/or the circle associated with the answer, and/or circling the answer.

Capture response instructions 132 may, for example, detect the pen/pencil marks that have been added to the responses by differentiating between the layout of the question before and after the responses have been written in. A pixel-by-pixel comparison, for example, may compare a color value for each relative pixel to determine if new writing has been added. A white pixel may read as a hex value of #FFFFFF, while a grey pixel (representing a pencil mark in this example) may read as a hex value of #474747. These values are only examples, as numerous other values may be represented, as the detection may rely on a threshold difference in the values to determine that a mark has been made. In some implementations, larger sample areas than a single pixel may be compared, such as by averaging the color values of the area and comparing between the before and after layouts. Once areas of writing have been detected, they may be assembled into shapes, such as be connecting marked pixels into an “X” or circle shape and then identifying the relative location of the shape to associate that shape with a particular answer. Comparison of pixel value differences is offered as an example only, and other methods of scanning and detection of markings on the responses are contemplated.

In some implementations, capturing the responses may comprise scanning the printed plurality of questions, recognizing a layout of each of the plurality of questions, and capturing a response in a response area associated with each of the plurality of questions. Capturing the response in the response area associated with each of the plurality of questions may comprise recognizing at least one printed indicator of the response area for at least one of the questions. For example, the boundary lines of pre-defined answer area 325 may be used to limit the area scanned for a response to question 320.

Method 400 may then advance to stage 415 where device 100 may associate the set of responses with a person according to a unique identifier encoded in a machine-readable code associated with the printed plurality of questions. For example, scan ink instructions 134 may scan a machine-readable link comprising a unique identifier associated with the plurality of questions. The unique identifier may identify a student associated with the responses and/or may provide layout information for the test. For example, the unique identifier may specify that of 10 possible questions, the associated test presented the questions in the order 3, 7, 1, 2, 9, 10, 8, 4, 6, 5. This may be used to retrieve and/or recreate the layout of the unmarked questions to aid in comparison and detection of the response markings.

The captured questions may be associated with a machine-readable code of the unique identifier. The machine-readable code may comprise, for example, a bar code, a matrix code, a text string, and a watermark. The machine-readable code may be visible to a person, such as a large bar code, and/or may not be readily visible, such as a translucent watermark and/or a set of steganography dots. The code may be used to identify the selected questions, a class period, a student, and/or additional information. In some implementations, the code may be added in multiple sections, such as a small matrix code at one and/or more of the corners of the page.

Associate unique identifier instructions 136 may associate the set of responses with the unique identifier. The unique identifier may be used to associate the responses with a particular student. For example, each test paper may have a different identifier even when the questions appear in the same order. This identifier may be associated with a particular student's name and/or student identifier. For example, OCR may be used to recognize the student's written name on the paper. In some implementations, only the unique identifier may be used during assessment and scoring by the instructor in order to anonymize the responses and prevent grading bias. The unique identifier and student name may be associated without being visible, such as by storing the relationship in a database, such that the grades, comments, and any other assessments may be provided to the student.

Method 400 may then advance to stage 420 where device 100 may compare a first response of the set of responses to an answer key to determine whether the first response of the set of responses comprises a correct response. In some implementations, capture response instructions 132 may further compare at least one response of the set of responses to an answer key of correct responses. For example, once a filled-in circle next has been identified and located next to answer choice B, the correct answer for the question may be retrieved and compared. If the correct answer is B, then the question may be scored as correct; otherwise the question may be scored as incorrect. In some implementations, the correct answer may be displayed next to the captured answer for verification by an instructor. For example, for a short answer response, the text of the response may be displayed next to an expected answer. In other examples, stored answer keywords may be compared to the captured response, such as via optical character recognition (OCR). The keywords may be used to mark the response as correct or incorrect, and/or may be used to highlight appropriate words in the response to aid an instructor when reviewing the responses. For example, certain names may be highlighted in a history essay response.

Upon detection of a correct and/or incorrect response, an indication of the correctness may be provided. For example, capture response instructions 132 may provide a printout and/or display of all scored responses and/or an indication of which response should have been entered. For another example, capture response instructions 132 may provide a count of correct and/or incorrect responses.

Method 400 may then advance to stage 425 where device 100 may receive an analysis of a second response of the set of responses. For example, device 100 may display one of the questions and the captured response from one and/or a plurality of students. An instructor may review the displayed responses via a user interface and provide analysis, feedback, and/or assessment. For example, the instructor may use grading software to mark a response as correct or incorrect and/or to provide comments on the response. The provided analysis may be stored, such as in a database, and presented to the student, such as via email, display on a screen, and/or printout. In some implementations, the user interface may display each response to a first question of the plurality of questions in a random order. For example, the user interface may display each students response to question 2 in succession and/or at least partially simultaneously (e.g., multiple responses at once). The responses may be displayed in a randomized order rather than in an order received, identifier, name, and/or otherwise sorted order. The responses may be displayed in an anonymized fashion, absent an identification of the person associated with the set of responses. In some implementations, no identifiers may be shown such that no indication is given that the same user submitted any two particular responses. In other implementations, the unique identifier (or other consistent identifier) may be displayed such that an instructor may know that different responses are associated with the same student without knowing which student that is.

In some implementations, the comparisons and/or received analyses may be aggregated into a plurality of determinations of whether the set of responses are correct into a score for the person. For example, a particular student's set of responses may comprise five multiple choice answers of which four were determined to be correct by comparison and five short-answer responses, of which four were determined to be correct according to assessments received from the instructor. These evaluations may thus be aggregated into a total score of 8/10 correct. In some implementations, different questions may be stored as having different weights. For example, short answer questions may count twice as much as multiple choice, such that 4/5 correct short answer responses effectively count as 8/10 possible points to be added to 4/5 correct multiple choice answers before calculating a final score.

Method 400 may then end at stage 450.

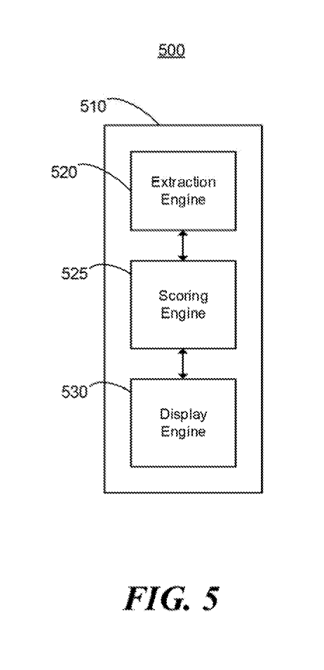

FIG. 5 is a block diagram of an example system 500 for providing question assessment. System 500 may comprise a computing device 510 comprising an extraction engine 520, a scoring engine 525 and a display engine 530. Engines 520, 525, and 530 may be associated with a single computing device 510 and/or may be communicatively coupled among different devices such as via a direct connection, bus, or network. Each of engines 520, 525, and 530 may comprise hardware and/or software associated with computing devices.

Extraction engine 520 may extract a set of responses associated with a plurality of questions from a printed layout of the plurality of questions, wherein the plurality of questions comprise a plurality of question types, and associate the set of responses with a person according to a unique identifier encoded in a machine-readable code associated with the printed plurality of questions.

In some implementations, extraction engine 520 may capture a set of responses to a plurality of questions, wherein the set of responses comprises at least one free-form response. Extraction engine 520 may, in some implementations, recognize a plurality of markup styles associated with a multiple choice type question. For example, a multiple choice response style may comprise a whole and/or partially filled-in circle, an X and/or other marking on the answer and/or the circle associated with the answer, and/or circling the answer.

Extraction engine 520 may, for example, detect the pen/pencil marks that have been added to the responses by differentiating between the layout of the question before and after the responses have been written in. A pixel-by-pixel comparison, for example, may compare a color value for each relative pixel to determine if new writing has been added. A white pixel may read as a hex value of #FFFFFF, while a grey pixel (representing a pencil mark in this example) may read as a hex value of #474747. These values are only examples, as numerous other values may be represented, as the detection may rely on a threshold difference in the values to determine that a mark has been made. In some implementations, larger sample areas than a single pixel may be compared, such as by averaging the color values of the area and comparing between the before and after layouts. Once areas of writing have been detected, they may be assembled into shapes, such as be connecting marked pixels into an “X” or circle shape and then identifying the relative location of the shape to associate that shape with a particular answer. Comparison of pixel value differences is offered as an example only, and other methods of scanning and detection of markings on the responses are contemplated.

The questions may be stored in a question database associated with a teaching/instructional application. Such questions and their layout may be retrieved to compare to the marked up version to aid in capturing the responses. For example, an instructor may enter the questions in an app on their tablet and/or smart device, through a web-based user interface, through an application on a desktop or laptop, etc. Each question may comprise the actual display information of the question (text, figures, drawings, references, tables, etc.), a question type (e.g., short answer, multiple choice, sketch, essay, etc.), and/or any constraint rules, as described above. For multiple-choice type questions, the answer choices may also be entered. The question type may be then be used to define an amount of space needed on a page. For example, a multiple choice question may require two lines for the question, an empty space line, and a line for the list of possible answers. For free-form and/or essay type questions, the instructor may enter a recommended amount of answer space (e.g., three lines, half a page, a full page, etc.). The instructor/teacher may also enter the correct answers and/or keywords into the application for later grading.

Extraction engine 520 may, for example, scan a machine-readable link comprising a unique identifier associated with the plurality of questions. The unique identifier may identify a student associated with the responses and/or may provide layout information for the test. For example, the unique identifier may specify that of 10 possible questions, the associated test presented the questions in the order 3, 7, 1, 2, 9, 10, 8, 4, 6, 5. This may be used to retrieve and/or recreate the layout of the unmarked questions to aid in comparison and detection of the response markings. The captured questions may be associated with a machine-readable code of the unique identifier. The machine-readable code may comprise, for example, a bar code, a matrix code, a text string, and a watermark. The machine-readable code may be visible to a person, such as a large bar code, and/or may not be readily visible, such as a translucent watermark and/or a set of steganography dots. The code may be used to identify the selected questions, a class period, a student, and/or additional information. In some implementations, the code may be added in multiple sections, such as a small matrix code at one and/or more of the corners of the page.

Extraction engine 520 may, for example, associate the set of responses with the unique identifier. The unique identifier may be used to associate the responses with a particular student. For example, each test paper may have a different identifier even when the questions appear in the same order. This identifier may be associated with a particular student's name and/or student identifier. For example, OCR may be used to recognize the student's written name on the paper. In some implementations, only the unique identifier may be used during assessment and scoring by the instructor in order to anonymize the responses and prevent grading bias. The unique identifier and student name may be associated without being visible, such as by storing the relationship in a database, such that the grades, comments, and any other assessments may be provided to the student.

Scoring engine 525 may compare a first response of the set of responses to an answer key to determine whether the first response comprises a correct response to a first question of the plurality of questions, and receive, from an instructor, a determination of whether a second response of the set of responses comprises a correct response to a second question of the plurality of questions. In some implementations, scoring engine 525 may compare at least one response of the set of responses to an answer key of correct responses. For example, once a filled-in circle next has been identified and located next to answer choice B, the correct answer for the question may be retrieved and compared. If the correct answer is B, then the question may be scored as correct; otherwise the question may be scored as incorrect. In some implementations, the correct answer may be displayed next to the captured answer for verification by an instructor. For example, for a short answer response, the text of the response may be displayed next to an expected answer. In other examples, stored answer keywords may be compared to the captured response, such as via optical character recognition (OCR). The keywords may be used to mark the response as correct or incorrect, and/or may be used to highlight appropriate words in the response to aid an instructor when reviewing the responses. For example, certain names may be highlighted in a history essay response.

Upon detection of a correct and/or incorrect response, an indication of the correctness may be provided. For example, capture response instructions 132 may provide a printout and/or display of all scored responses and/or an indication of which response should have been entered. For another example, capture response instructions 132 may provide a count of correct and/or incorrect responses.

In some implementations, scoring engine 525 may receive an analysis of a second response of the set of responses. For example, system 500 may display one of the questions and the captured response from one and/or a plurality of students. An instructor may review the displayed responses via a user interface and provide analysis, feedback, and/or assessment. For example, the instructor may use grading software to mark a response as correct or incorrect and/or to provide comments on the response. The provided analysis may be stored, such as in a database, and presented to the student, such as via email, display on a screen, and/or printout. In some implementations, the user interface may display each response to a first question of the plurality of questions in a random order. For example, the user interface may display each student's response to question 2 in succession and/or at least partially simultaneously (e.g., multiple responses at once). The responses may be displayed in a randomized order or may be displayed in a sorted order, such as in the order received, ordered by identifier, and/or ordered by name. The responses may be displayed in an anonymized fashion, absent an identification of the person associated with the set of responses. In some implementations, no identifiers may be shown such that no indication is given that the same user submitted any two particular responses. In other implementations, the unique identifier (or other consistent identifier) may be displayed such that an instructor may know that different responses are associated with the same student without knowing which student that is.

In some implementations, the comparisons and/or received analyses may be aggregated into a plurality of determinations of whether the set of responses are correct into a score for the person. For example, a particular student's set of responses may comprise five multiple choice answers of which four were determined to be correct by comparison and five short-answer responses, of which four were determined to be correct according to assessments received from the instructor. These evaluations may thus be aggregated into a total score of 8/10 correct. In some implementations, different questions may be stored as having different weights. For example, short answer questions may count twice as much as multiple choice, such that 4/5 correct short answer responses effectively count as 8/10 possible points to be added to 4/5 correct multiple choice answers before calculating a final score.

Display engine 530 may display the determinations of a correctness of each of the set of responses to the person associated with the plurality of questions. For example, a user interface (such as a web application) may be used to display assessments of correctness for each of the responses and/or an overall grade.

The disclosed examples may include systems, devices, computer-readable storage media, and methods for question assessment. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions to:
capture a set of responses to a plurality of questions, wherein the set of responses comprises at least one free-form response;
scan a machine-readable link comprising a unique identifier associated with the plurality of questions; and
associate the set of responses with the unique identifier.

2. The non-transitory machine-readable medium of claim 1, wherein the instructions to capture the set of responses to a plurality of questions comprise instructions to recognize a plurality of markup styles associated with a multiple choice type question.

3. The non-transitory machine-readable medium of claim 1, wherein the instructions to capture the set of responses comprise instructions to perform optical character recognition on at least one of the responses.

4. The non-transitory machine-readable medium of claim 1, further comprising instructions to compare at least one response of the set of responses to an answer key of correct responses.

5. The non-transitory machine-readable medium of claim 4, wherein the instructions to compare at least one response of the set of responses to an answer key of correct responses further comprise instructions to determine whether the at least one response comprises a correct response.

6. The non-transitory machine-readable medium of claim 5, wherein the instructions to determine whether the at least one response comprises a correct response further comprise instructions to provide an indication of whether the at least one response is correct.

7. A computer-implemented method, comprising:
capturing a set of responses associated with a printed plurality of questions, wherein the plurality of questions comprise a plurality of question types;
associating the set of responses with a person according to a unique identifier encoded in a machine-readable code associated with the printed plurality of questions;
comparing a first response of the set of responses to an answer key to determine whether the first response of the set of responses comprises a correct response; and
receiving an analysis of a second response of the set of responses.

8. The computer-implemented method of claim 7, wherein the analysis comprises a determination of whether the second response comprises a correct response.

9. The computer-implemented method of claim 8, further comprising aggregating a plurality of determinations of whether the set of responses are correct into a score for the person.

10. The computer-implemented method of claim 7, wherein the analysis of the second response is received from an instructor via a user interface.

11. The computer-implemented method of claim 10, wherein the user interface displays each response to a first question of the plurality of questions in a random order.

12. The computer-implemented method of claim 10, wherein the user interface displays each response to a first question of the plurality of questions absent an identification of the person associated with the set of responses.

13. The computer-implemented method of claim 7, wherein extracting the set of responses comprises:
scanning the printed plurality of questions;
recognizing a layout of each of the plurality of questions; and
capturing a response in a response area associated with each of the plurality of questions.

14. The computer-implemented method of claim 13, wherein capturing the response in the response area associated with each of the plurality of questions comprises recognizing at least one printed indicator of the response area for at least one of the questions.

15. A system, comprising:
an extraction engine to:
extract a set of responses associated with a plurality of questions from a printed layout of the plurality of questions, wherein the plurality of questions comprise a plurality of question types, and
associate the set of responses with a person according to a unique identifier encoded in a machine-readable code associated with the printed plurality of questions;
a scoring engine to:
compare a first response of the set of responses to an answer key to determine whether the first response comprises a correct response to a first question of the plurality of questions, and
receive, from an instructor, a determination of whether a second response of the set of responses comprises a correct response to a second question of the plurality of questions; and
a display engine to:
display the determinations of a correctness of each of the set of responses to the person associated with the plurality of questions.
